(19) United States
(12) Patent Application Publication
(10) Pub. No.: US 2018/0007931 A1
(43) Pub. Date: Jan. 11, 2018

(54) FROZEN FOOD DRIP PREVENTION DEVICE

(71) Applicants: Kathryn Kriste Rosenberg, Orem, UT (US); Joshua Hileman Rosenberg, Orem, UT (US)

(72) Inventors: Kathryn Kriste Rosenberg, Orem, UT (US); Joshua Hileman Rosenberg, Orem, UT (US)

(21) Appl. No.: 15/643,189

(22) Filed: Jul. 6, 2017

Related U.S. Application Data
(60) Provisional application No. 62/359,149, filed on Jul. 6, 2016.

(51) Int. Cl. A23G 9/50

(52) U.S. Cl. CPC A23G 9/503

(57) ABSTRACT

A frozen food drip prevention device includes an interior fluid basin and an aperture. The aperture is configured to couple to the handle stick of a frozen treat. The interior fluid basin is configured to capture and hold fluid from a melting frozen treat.

### CROSS REFERENCE TO RELATED APPLICATIONS

The present application claims priority benefit from U.S. Provisional Patent Application No. 62/359,149, filed on Jul. 6, 2016, titled “Frozen Treat Drip Prevention Device”, which application is incorporated herein by reference in its entirety.

### BACKGROUND

### Technical Field

The present disclosure relates to the field of utensils for assisting in the consumption of food.

### Description of the Related Art

Many kinds of foods are liable to spill, drip, or otherwise create messes and stain clothing or other items. For example, some foods, such as frozen juice treats, are typically frozen prior to consumption. While frozen juice treats are being eaten they typically begin to melt. As the frozen juice treats melt, they drip. As the frozen juice treats drip, they can stain floors, furniture, and clothing and can otherwise create messes that can be difficult, expensive, and inconvenient to clean.

### BRIEF SUMMARY

One embodiment is a frozen food drip prevention device. The frozen food drip prevention device is configured to couple to a frozen treat and catch fluid from the frozen treat as the frozen treat melts. The frozen food drip prevention device can couple to a stick or handle of a frozen treat, such as a frozen juice treat. The frozen food drip prevention device includes an interior fluid basin figured to catch and hold drips from the frozen treat as the frozen treat melts. In this way, even if the frozen treat begins to melt, the frozen food drip prevention device can catch and hold the drips so that they do not create an undesirable mess.

### BRIEF DESCRIPTION OF THE SEVERAL VIEWS OF THE DRAWINGS

FIG. 1A is a side view of a frozen food drip prevention device coupled to a frozen treat, according to an embodiment.

FIG. 1B is an isometric top view of a frozen food drip prevention device, according to an embodiment.

FIG. 1C is a top view of a frozen food drip prevention device, according to an embodiment.

FIG. 1D is an isometric bottom view of a frozen food drip prevention device, according to an embodiment.

FIG. 1E is a side view of a frozen food drip prevention device, according to an embodiment.

FIG. 1F is a bottom view of a frozen food drip prevention device, according to an embodiment.

FIG. 1G is a side view of a frozen food drip prevention device, according to an embodiment.

FIG. 1H is a sectional view of a frozen food drip prevention device, according to an embodiment.

FIG. 2A is a perspective view of a frozen food drip prevention device coupled to a frozen treat handle stick, according to an embodiment.

FIG. 2B is a perspective view of the frozen food drip prevention device of FIG. 1A not coupled to the frozen treat handle stick, according to an embodiment.

FIG. 2C is a perspective view of a section of the frozen food drip prevention device of FIG. 2A, according to an embodiment.

FIG. 3A is a perspective view of a frozen food drip prevention device coupled to a frozen treat handle stick, according to an embodiment.

FIG. 3B is a perspective view of the frozen food drip prevention device of FIG. 3A without being coupled to the frozen treat handle stick, according to an embodiment.

FIG. 3C is a perspective view of a section of the frozen food drip prevention device of FIG. 3A, according to an embodiment.

### DETAILED DESCRIPTION

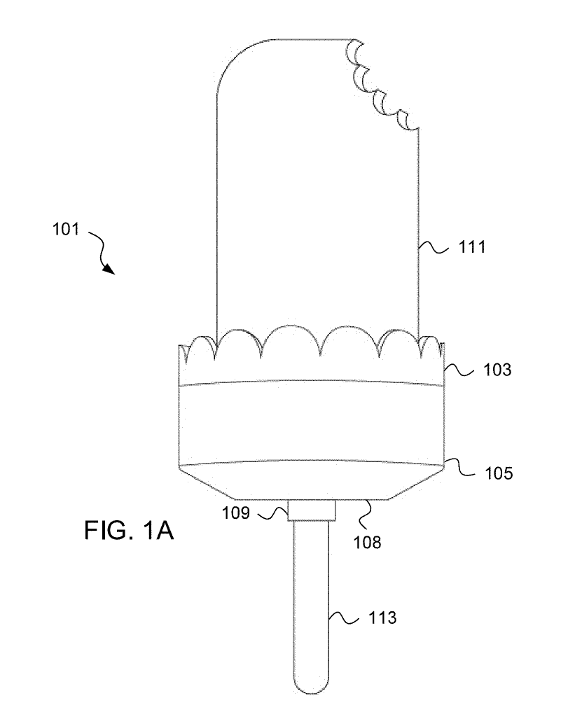

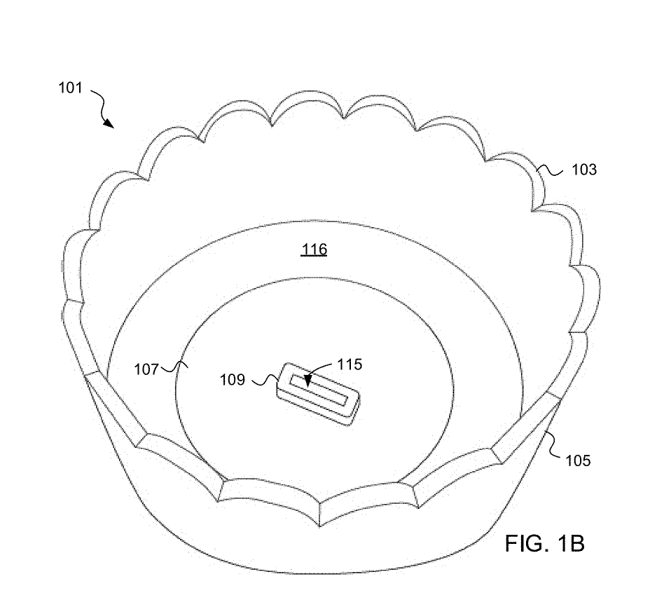

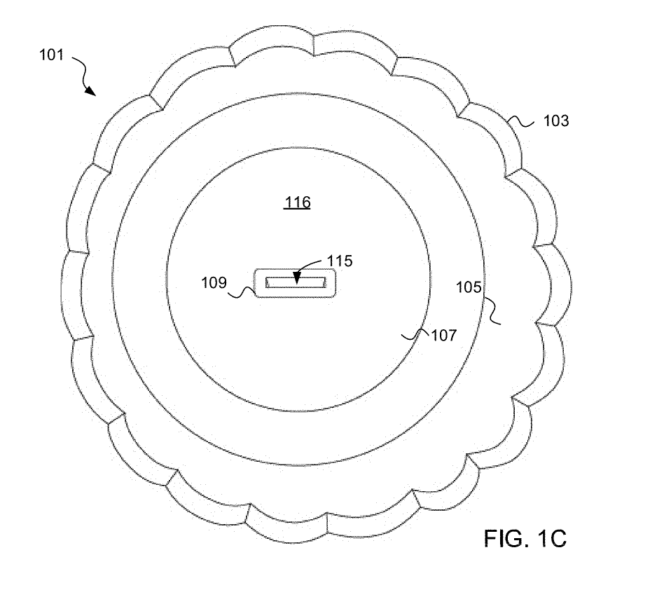

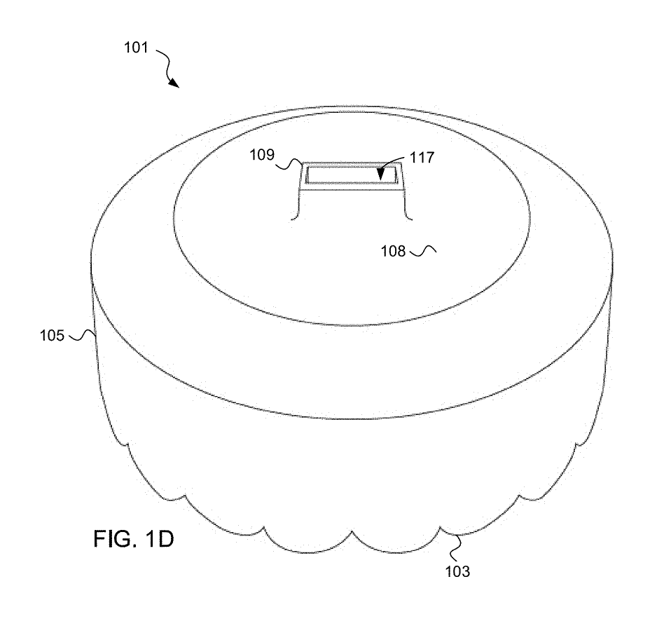

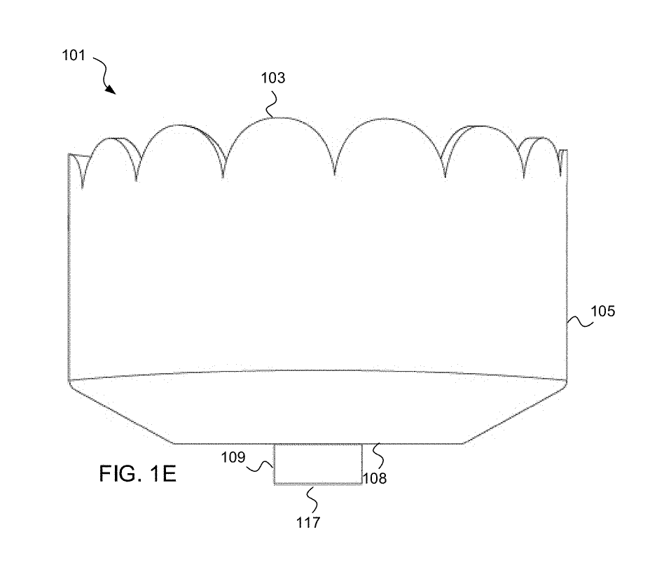

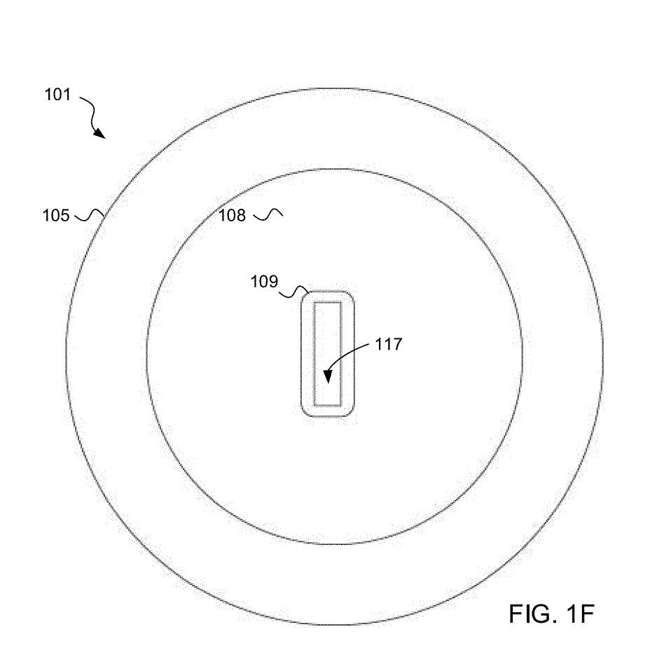

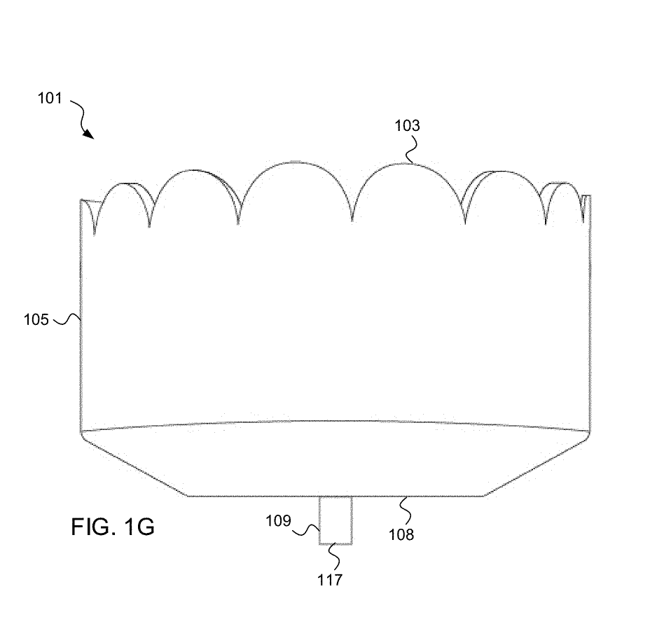

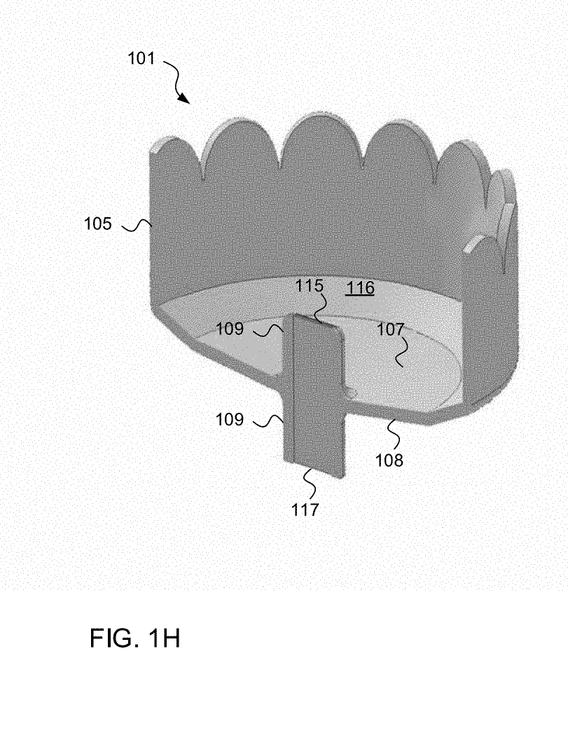

FIG. 1A is a side view of a frozen food drip prevention device 101, according to one embodiment. The frozen food drip prevention device 101 includes a cup 105 that defines an interior basin 116 (FIG. 1B). The frozen food drip prevention device 101 is coupled to a frozen treat 111. In particular, a handle stick 113 of the frozen treat 111 is positioned in an interior channel of a wall 109 extending below a bottom exterior surface 108 of the cup 105. The handle stick 113 extends through the interior channel of the wall 109 between a first aperture 115 (FIG. 1B) and second aperture 117 (FIG. 1D). The first aperture 115, the interior channel, and the second aperture 117 are configured to tightly receive and hold the handle stick 113.

In one embodiment, as the frozen treat 111 melts, the fluid from the frozen treat 116 is captured by and held within the interior fluid basin 116. In this way, the frozen food drip prevention device 101 prevents drips from a melting frozen treat from getting on the skin of the person, or from staining clothing, floors, furniture, or anything else.

In one embodiment, the cup 105 has a total diameter of about 6 cm. The wall 109 passes about 0.5 cm below the bottom surface 108 of the cup 105 and about 0.5 cm above the interior bottom surface 107 (FIG. 1B) within the interior fluid basin 116. In one embodiment, the depth of the interior fluid basin 116 is about 3 cm. Those of skill in the art will recognize, in light of the present disclosure, that the frozen food drip prevention device 101 can include other dimensions than those described herein. Furthermore, the frozen food drip prevention device 101 can include shapes other than those disclosed in FIG. 1A. All such other shapes and dimensions fall within the scope of the present disclosure.

In one embodiment, the cup 105 includes decorative semicircular ridges 103 along a top of the cup 105.

FIG. 1B is an isometric top view of the frozen food drip prevention device 101 of FIG. 1A, according to an embodiment. The view of FIG. 1B illustrates the interior basin 116 defined by the cup 105. The view of FIG. 1B also illustrates the wall 109 protruding from the bottom interior surface 107 of the cup 105. The wall 109 includes a first aperture 115 providing access to an interior channel within the wall 109. The first aperture 115 and the interior channel are configured to receive a handle stick 113 of a frozen treat 111 or other frozen food and to tightly hold the handle stick 113.

In one embodiment, as the frozen treat 111 melts, the melting fluid is captured and held within the interior basin 116 of the cup 105. Because the aperture 115 is elevated above the bottom interior surface 107, and because the handle stick fits tightly within the interior channel of the wall 109, the melting fluid does not flow through the aperture 115 and spill out the bottom of the cup 105. In this way, the frozen treat drip prevention device prevents the melting frozen treat fluid from causing stains and stickiness.

FIG. 1C is a top view of the frozen food drip prevention device 101 of FIGS. 1A and 1B, according to an embodiment. The wall 109, the first aperture 115, the interior bottom surface 107, and the ridges 103 are visible in the top view of FIG. 1C.

FIG. 1D is an isometric bottom view of the frozen food drip prevention device 101 of FIGS. 1A-1C, according to an embodiment. The bottom isometric view illustrates the wall 109 protruding from the bottom exterior surface 108 of the cup 105. The bottom isometric view also illustrates the second aperture 117 in the wall 109. The interior channel of the wall 109 extends between the first aperture 115 and the second aperture 117. In one embodiment, the interior channel has a cross-section that is the same as the cross-sections of the first aperture 115 and the second aperture 117.

FIG. 1E is a side view of the frozen food drip prevention device 101 of FIGS. 1A-1D, according to an embodiment. The side view is substantially similar to the side view of FIG. 1A, except that the frozen treat 111 is not held by the frozen treat drip prevention device 101.

FIG. 1F a bottom view of the frozen food drip prevention device 101 of FIGS. 1A-1E, according to an embodiment. The bottom isometric view illustrates the wall 109 and the bottom exterior surface 108 of the cup 105. The bottom view also illustrates the second aperture 117 in the wall 109. The interior channel of the wall 109 extends between the first aperture 115 and the second aperture 117.

FIG. 1G is a side view of the frozen food drip prevention device 101 of FIGS. 1A-1F, according to an embodiment. The side view of FIG. 1G is substantially similar to the side view of FIG. 1E, except that the side view of FIG. 1G shows the smaller width dimension of the wall 109, compared to the view of FIG. 1E.

FIG. 1H is an elevated sectional view of the frozen food drip prevention device 101, according to an embodiment. The sectional view does not pass directly through the center of the cup 105, but instead passes nearly through the center such that the entirety of the wall 109 is visible. The interior basin 116, the bottom interior surface 107, and the first aperture are visible in the sectional view of FIG. 1H.

In one embodiment, the frozen food drip prevention device 101 is made from a plastic material such as silicone. The frozen food drip prevention device can include a material such as silicone, rubber, plastic, wood, metal, or any other suitable material. The frozen food drip prevention device 201 can be flexible. Alternatively, the frozen food drip prevention device 201 can be rigid.

In one embodiment, the wall 109 can be a mound, a ridge, a bump, or another structure that extends from one or both of the interior bottom surface 107 and the exterior bottom surface 108. The wall 109 can be unitary or integral with the cup 105. Alternatively, the wall 109 can be a separate component fixed to the cup 105.

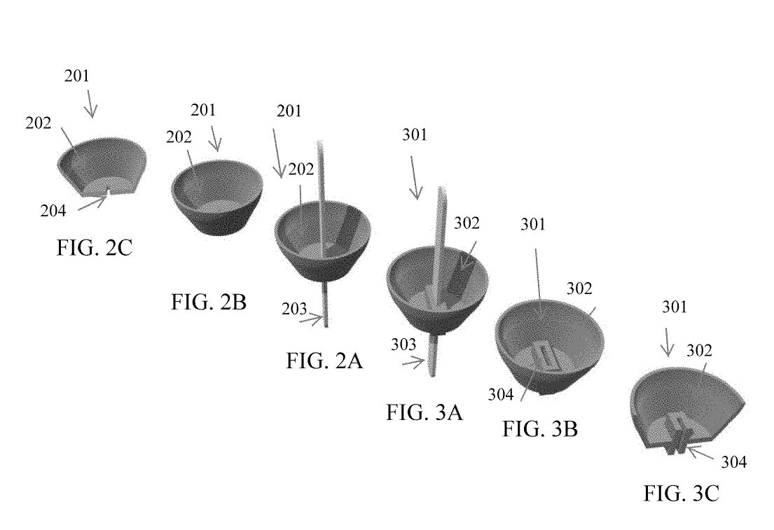

FIG. 2A is a perspective view of a frozen food drip prevention device 201, according to an embodiment. The frozen food drip prevention device 201 defines an interior fluid basin 202 and an aperture 204 (see FIG. 2C).

The frozen food drip prevention device 201 is configured to couple to the handle stick of a frozen treat. In FIG. 2A, a frozen treat handle stick 203 is passed through the aperture 204. The aperture 204 is configured to fit tightly to the frozen treat handle stick 203. In this way, the frozen food drip prevention device 201 is configured to be coupled to a frozen treat by passing the handle stick 203 of the frozen treat through the aperture 204. In one embodiment, the aperture 204 is configured to grip the handle stick in such a way that the handle stick does not easily slide relative to the aperture 204 after the handle stick has been positioned in the aperture 204.

In one embodiment, the interior fluid basin 202 is configured to capture and hold fluid from the frozen treat as the frozen treat melts. Thus, as the frozen treat melts, the fluid gradually fills a portion of the interior fluid basin 202. In this way, fluid that melts from the frozen treat does not spill or drip onto the skin of a person, the floor, furniture or clothing. In one embodiment, the aperture 204 is configured to not allow the fluid to pass through the aperture 204 when the handle stick is in the aperture 204. The aperture 204 can optionally include one or more flexible flanges configured to hold the handle stick 203 and/or to prevent fluid from passing through the aperture 204.

In one embodiment, the frozen treat is a frozen juice treat and the handle stick is a typical frozen juice treat stick. The aperture 204 is sized to fit tightly with a typical frozen juice treat stick. A person can use the frozen food drip prevention device 201 to prevent drips from the frozen juice treat. In particular, the person can unwrap a frozen juice treat, lower the lower end of the frozen juice treat stick through the aperture 204, and then hold the portion of the frozen juice treat stick that protrudes below the aperture 204. The person can eat the frozen juice treat without worrying about drips as the frozen juice treat melts. As the frozen juice treat melts, the frozen juice treat juice will pool in the interior fluid basin 202. The frozen juice treat juice will not pass through the aperture 204 because the frozen juice treat stick fills the aperture 204. In this way, the person can enjoy frozen juice treat without sustaining clothing and/or floors, and without getting sticky frozen juice treat juice on his or her skin.

In one embodiment, the frozen food drip prevention device 201 is made from a plastic material such as silicone. The frozen food drip prevention device can include a material such as silicone, rubber, plastic, wood, metal, or any other suitable material. The frozen food drip prevention device 201 can be flexible. Alternatively, the frozen food drip prevention device 201 can be rigid.

FIG. 2B is a view of the frozen food drip prevention device 201 of FIG. 2A without being coupled to handle stick 203.

FIG. 2C is a cutaway view of a portion of the frozen food drip prevention device 201 of FIG. 2A, according to an embodiment. The view of FIG. 2C illustrates that the aperture 204 is positioned at the center of the bottom portion of the interior fluid basin 202.

FIG. 3A is a perspective view of a frozen food drip prevention device 301, according to an embodiment. The frozen food drip prevention device 301 defines an interior fluid basin 302 and an aperture 304. The frozen food drip prevention device 301 is similar to the frozen food drip prevention device 201, except that the aperture 304 protrudes above and below the bottom of the interior fluid basin 302.

The frozen food drip prevention device 301 is configured to couple to the handle stick of a frozen treat. In FIG. 3A, a frozen treat handle stick 303 is passed through the aperture 304. The aperture 304 protrudes from the bottom of the interior fluid basin 302. The aperture 304 is configured to form fit tightly to the frozen treat handle stick 303. In this way, the frozen food drip prevention device 301 is configured to be coupled to a frozen treat by passing the handle stick of the frozen treat 30 aperture 304. In one embodiment, the aperture 304 is configured to grip the handle stick in such a way that the handle stick does not easily slide relative to the aperture 304 after the handle stick has been positioned in the aperture 304.

In one embodiment, the interior fluid basin 302 is configured to capture and hold fluid from the frozen treat as the frozen treat melts. Thus, as the frozen treat melts, the fluid gradually fills a portion of the interior fluid basin 302. In this way, fluid that melts from the frozen treat does not spill or drip onto the skin of a person, the floor, or clothing. In one embodiment, the aperture 304 is configured to not allow the fluid to pass through the aperture 304 when the handle stick is in the aperture 304.

In one embodiment, the frozen treat is a frozen juice treat and the handle stick is a typical frozen juice treat stick. The aperture 304 is sized to fit tightly with a typical frozen juice treat stick. A person can use the frozen food drip prevention device 301 to prevent drips from the frozen juice treat. In particular, the person can unwrap a frozen juice treat, lower the lower end of the frozen juice treat stick through the aperture 304, and then hold the portion of the frozen juice treat stick that protrudes below the aperture 304. The person can eat the frozen juice treat without worrying about drips as the frozen juice treat melts. As the frozen juice treat melts, the frozen juice treat juice will pool in the interior fluid basin 302. The frozen juice treat juice will not pass through the aperture 304 because the frozen juice treat stick fills the aperture 304 and because the aperture 304 is raised above the floor of the interior fluid basin 302. In this way, the person can enjoy frozen juice treat without sustaining clothing and/or floors, and without getting sticky frozen juice treat juice on his or her skin.

In one embodiment, the frozen food drip prevention device 301 is made from a plastic material such as silicone. The frozen food drip prevention device can include a silicone, rubber, plastic, wood, metal, or any other suitable material. The frozen food drip prevention device 301 can be flexible. Alternatively, the frozen food drip prevention device 301 can be rigid.

FIG. 3B is a view of the frozen food drip prevention device 301 of FIG. 3A without being coupled to handle stick 303.

FIG. 3C is a cutaway view of a portion of the frozen food drip prevention device 301 of FIG. 3A, according to an embodiment. The view of FIG. 3C illustrates that the aperture 304 is positioned at the center of the bottom portion of the interior fluid basin 302.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A frozen food drip prevention device, comprising:
a cup including defining an interior basin;
a wall in the basin;
a first aperture in a top of the wall elevated above a bottom of the basin; and
an interior channel in the wall configured to receive a handle stick of a frozen treat via the first aperture and to hold the handle stick.

2. The frozen food drip prevention device of claim 1, further comprising a second aperture below the cup, the interior channel extending between the first and second aperture.

3. The frozen food drip prevention device of claim 2, wherein the interior channel is configured to hold the handle stick such that the handle stick protrudes above the first aperture and below the second aperture.

4. The frozen food drop prevention device of claim 3, wherein a portion of the wall extends below a bottom of the cup.

5. The frozen food drip prevention device of claim 4, wherein the second aperture is positioned below the bottom of the cup.

6. The frozen food drip prevention device of claim 2, wherein the first aperture, the second aperture, and the interior channel have a substantially rectangular cross-section.

7. The frozen food drip prevention device of claim 2, wherein the cup and the wall are unitary.

8. The frozen food drip prevention device of claim 1, wherein the interior basin is about 6 cm in diameter.

9. The frozen food drip prevention device of claim 1, wherein the wall protrudes about 0.5 cm above a bottom of the cup.

10. The frozen food drip prevention device of claim 1, wherein the interior channel and the first aperture configure to prevent fluid from flowing through from the basin through the interior channel when the handle stick is positioned in the interior channel.

11. The frozen food drip prevention device of claim 1, wherein the basin is configured to capture and hold fluid from the frozen treat when the handle stick is positioned in the interior channel and the frozen treat melts.

12. The frozen food drip prevention device of claim 1, wherein the cup includes a plastic material.

13. The frozen food drip prevention device of claim 1, wherein the cup includes silicone.

14. The frozen food drip prevention device of claim 1, wherein the interior basin is about 3 cm deep.

15. The frozen food drip prevention device of claim 1, wherein the cup is flexible.

16. The frozen food drip prevention device of claim 1, wherein the wall is in a center of the bottom of the cup.

17. The frozen food drip prevention device of claim 1, wherein the wall protrudes above the bottom of the basin within the basin and below the bottom of the cup.
